(19) United States
(12) Patent Application Publication
(10) Pub. No.: US 2008/0317377 A1
(43) Pub. Date: Dec. 25, 2008

(54) IMAGE CODING APPARATUS AND IMAGE CODING METHOD

(76) Inventors: Katsuo SAIGO, Hyogo (JP); Tatsuro Juri, Osaka (JP); Hideyuki Ohgose, Osaka (JP); Koji Arimura, Osaka (JP); Hiroshi Arakawa, Nara (JP); Kei Tasaka, Osaka (JP); Yuki Maruyama, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/142,470

(22) Filed: Jun. 19, 2008

(30) Foreign Application Priority Data
Jun. 19, 2007 (JP) 2007-161913

(51) Int. Cl. G06K 9/00

(52) U.S. Cl. 382/274; 382/239

(57) ABSTRACT

The image coding apparatus according to the present invention is an image coding apparatus, including an imaging unit, a chroma quantization width adjustment unit configured to determine a chroma quantization width using a first method when the amount of the incident light on the imaging unit is larger than the predetermined amount, and to adjust the chroma quantization width such that the chroma quantization width is larger than a quantization width determined using the first method when the light amount judging unit judges that the amount of the incident light is smaller than the predetermined amount, and a luma quantization width adjustment unit configured to determine a luma quantization width using a second method without being dependent on the amount of the incident light.

### BACKGROUND OF THE INVENTION

(1) Field of the Invention

The present invention relates to image coding apparatuses and image coding methods for coding image data, and more particularly to an image coding apparatus and an image coding method capable of effectively suppressing chromatic noise in the dark.

(2) Description of the Related Art

When imaging night view or a dark room by a digital video camera or a digital still camera having imaging devices such as Charge Coupled Devices (CCD) and Complementary Metal Oxide Semiconductors (CMOS), optical amplification is performed in order to improve sensitivity when receiving light, since the amount of incident light to an imaging device is small. However, when the optical amplification is performed, random optical noise is also amplified in addition to optical component of the original subject. More specifically, in a dark region having low luma level, dot chromatic noise which is not supposed to exist tends to be generated, causing visually prominent degradation in an image.

An apparatus which suppresses dark noise generated when imaging under low illuminance and codes an image has been proposed. For example, there has been proposed an apparatus which controls frequency characteristics and gamma characteristics of an inputted image signal based on an aperture value and gain of the camera as signal processing on the imaging side before coding, to reduce the amount of information of inputted image, so that the noise is suppressed (for example, see Japanese Unexamined Patent Application Publication No. 2005-260640).

In addition, as suppressing noise on the coding side, an apparatus which suppresses noise by reducing a frequency coefficient (especially high frequency transform coefficient of the chroma component) of an input image that has been frequency resolved based on imaging conditions such as imaging sensitivity (for example, see Japanese Unexamined Patent Application Publication No. 2002-314999).

In addition, among apparatuses that codes images per block such as a macroblock, there have been proposed an apparatus which selects a quantization matrix optimal for suppressing noise from among quantization matrixes adjusted to the spatial characteristics of the block based on the characteristic of an image inputted per macroblock (noise information of an image, for example), and codes an image using the selected quantization matrix (see, for example, Japanese Unexamined Patent Application Publication No. 2006-109497).

According to the conventional technique disclosed in Japanese Unexamined Patent Application Publication No. 2005-260640, it is possible to suppress noise by reducing the amount of inputted image information before coding using the aperture value and the gain of the camera effectively. However, when noise is suppressed before coding, in addition to noise, information in input image component is also suppressed, and definition of the image falls. Furthermore, a signal processing circuit for suppressing noise needs to be provided in the front stage of a signal processing circuit for coding.

On the other hand, according to the conventional techniques disclosed in Japanese Unexamined Patent Application Publication No. 2002-314999 or Japanese Unexamined Patent Application Publication No. 2006-109497, noise in an input image can be reduced on the coding side without suppressing noise before coding. However, there are problems that new noise is generated depending on the degree of reduction of transform coefficients and selection of quantization matrix. For example, when enormous amount of noise is multiplexed in an inputted image signal, suppressing noise only by controlling quantization requires deletion of many of transform coefficients for the image data or preferential selection of a quantization matrix having an extremely wide quantization width. However, in an image coding method where coding is performed per block (such as JPEG, MPEG-2 and MPEG-4), when a compression rate is high, luma and color information is equalized, and tile-like block noise is generated.

### SUMMARY OF THE INVENTION

The present invention solves the problem, and it is an object of the present invention to provide an image coding apparatus and an image coding method capable of preventing block noise from being generated while effectively suppressing chromatic noise in the dark.

In order to achieve the above object, the image coding apparatus according to the present invention is an image coding apparatus that codes image data, including: an imaging unit configured to output the image data; a light amount judging unit configured to judge whether amount of incident light on the imaging unit is smaller than a predetermined amount; a chroma quantization width adjustment unit which determines a chroma quantization width using a first method when the light amount judging unit judges that the amount of the incident light is larger than the predetermined amount, and to adjust the chroma quantization width such that the chroma quantization width is larger than a quantization width determined using the first method when the light amount judging unit judges that the amount of the incident light is smaller than the predetermined amount, the chroma quantization width being a quantization width of chroma data that is chroma component of the image data; a chroma quantization unit which quantizes, as a part of the coding, the chroma data using the chroma quantization width that has been determined or adjusted by the chroma quantization width adjustment unit; a luma quantization width adjustment unit which determines a luma quantization width using a second method without being dependent on the judgment result by the light amount judging unit, the luma quantization width being a quantization width of luma data that is luma component of the image data; and a luma quantization unit which quantizes, as a part of the coding, the luma data using the luma quantization width that has been determined by the luma quantization width adjustment unit.

With this, the quantization width of the chroma data is adjusted to be large independent of the luma data when it is judged that the amount of incident light on the imaging unit is smaller than the predetermined amount, and thus it is possible to prevent the quantization width to be excessively large. As a result, it is possible to prevent generation of block noise as much as possible while effectively suppressing the chromatic noise in the dark.

Here, the image coding apparatus may further include: a chroma deblocking strength adjustment unit which determines a chroma deblocking strength using a third method when the chroma quantization width is not adjusted by the chroma quantization width adjustment unit, and to adjust the chroma deblocking strength such that the chroma deblocking strength is higher than a deblocking filter strength determined using the third method when the chroma quantization width is adjusted by the chroma quantization width adjustment unit, the chroma deblocking strength being a deblocking filter strength of the chroma data; a chroma deblocking unit which deblocks, as a part of the coding, the chroma data using the chroma deblocking strength that has been determined or adjusted by the chroma deblocking strength adjustment unit; a luma deblocking strength adjustment unit which determines a luma deblocking strength using a fourth method without being dependent on the judgment result by the light amount judging unit, the luma deblocking strength being a deblocking filter strength of the luma data; and a luma deblocking unit which deblocks, as a part of the coding, the luma data using the luma deblocking strength that has been determined by the luma deblocking strength adjustment unit.

With this, the deblocking filter strength of the chroma data is adjusted to be large independent of the luma data when the quantization width of the chroma data is adjusted, and thus it is possible to effectively suppress the block noise.

In addition, the chroma quantization width adjustment unit may adjust a quantization matrix value of the chroma data so as to lower or reduce high frequency component when the light amount judging unit judges that the amount of the incident light is smaller than the predetermined amount, and the chroma quantization unit is configured to quantize the chroma data using the adjusted quantization matrix value.

With this, the quantization matrix value of the chroma data is adjusted such that the high frequency component is lowered or reduced.

Furthermore, the light amount judging unit may judge that the amount of incident light is smaller than the predetermined amount in at least one of the following cases: where an aperture value used for controlling the amount of incident light is smaller than a predetermined value; and where a gain amplification value of a gain for amplifying the received light is larger than a predetermined value.

With this, it is possible to judge that the amount of incident light is smaller than the predetermined amount only by detecting that the aperture value is smaller than the predetermined value, or that the gain amplification value of the gain for amplifying received light is larger than the predetermined value.

Furthermore, the light amount judging unit may judge that the amount of incident light is smaller than the predetermined amount when the size of a luminance signal of incident light is smaller than the predetermined value.

With this it is possible to judge that the amount of incident light is smaller than the predetermined value only by detecting that the size of the luminance signal is smaller than the predetermined value.

Note that the chroma quantization width adjustment unit may determine, according to a table that indicates correspondence between values of the luma quantization width and values of the chroma quantization width, a value corresponding to a value of the luma quantization width that has been determined by the luma quantization width adjustment unit as the chroma quantization width when the light amount judging unit judges that the amount of the incident light is larger than the predetermined amount, and may adjust the chroma quantization width by adding an offset value to the luma quantization width that has been determined by the luma quantization width adjustment unit and determining, according to the table, a value corresponding to a value of the luma quantization width to which the offset value is added as the chroma quantization width when the light amount judging unit judges that the amount of the incident light is smaller than the predetermined amount.

Note that the chroma deblocking strength adjustment unit may determine, according to a table that indicates correspondence between values of the chroma quantization width and values of the chroma deblocking strength a value corresponding to a value of the chroma quantization width that has been determined by the chroma quantization width adjustment unit as the chroma deblocking strength when the chroma quantization width is not adjusted by the chroma quantization width adjustment unit, and may adjust the chroma deblocking strength by adding an offset value to the chroma quantization width that has been determined by the chroma quantization width adjustment unit and determining, according to the table, a value corresponding to a value of the chroma quantization width to which the offset value is added as the chroma deblocking strength when the chroma quantization width is not adjusted by the chroma quantization width adjustment unit.

Note that, the image coding apparatus may be compliant to the H.264 image coding standard.

It should be noted that the present invention may be implemented as, not only the image coding apparatus, but also as an image coding method including the characteristic components of the image coding apparatus as steps, and a program that causes a computer to execute these steps. Moreover, it is needless to say that such a program may be distributed via a recording medium such as a CD-ROM, or a transmission medium such as the Internet.

As described above, according to the image coding apparatus of the present invention, it is possible to effectively suppress dark noise generated in the imaging system, particularly the chromatic noise on the coding side, as well as block noise that tends to be generated on the coding side simultaneously.

Furthermore, the image coding apparatus according to the present invention is capable of adjusting the quantization width regarding the chroma data independently of the luma data. Therefore, the image coding apparatus is particularly effective for the case where the luminance (contour) is maintained while suppressing the chromatic noise. In other words, the present invention is exceptionally practical for the cases where only suppressing chromatic noise is effective since the noise caused by the variation in luminance is not prominent in the dark.

Further Information about Technical Background to this Application

The disclosure of Japanese Patent Application No. 2007-161913 filed on Jun. 19, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 shows an overview of the image coding apparatus according to the embodiment of the present invention;

FIG. 2 shows a configuration of the image coding apparatus according to the embodiment of the present invention;

FIG. 3 is a diagram for describing video signal of one picture in the 4:2:0 format;

FIG. 4 is a diagram for describing video signal of one macroblock in the 4:2:0 format;

FIG. 5 is a diagram for describing orthogonal transform blocks of one macroblock in the 4:2:0 format;

FIG. 6 illustrates relationship among the amount of incident light, the aperture value information in the imaging system, and the gain value in optical amplification;

FIG. 7 is a block diagram showing detailed configuration of the quantization/deblocking adjustment unit according to the embodiment of the present invention;

FIG. 8 is a diagram showing the configuration of the table that indicates correspondence between qP1 and the chroma quantization parameter Qpc;

FIG. 9 is a diagram for describing the quantization matrix;

FIG. 10 is a diagram for describing the deblocking method;

FIG. 11A is a diagram for showing configuration of the table that indicates the correspondence between the indexes A and B and the thresholds α and β;

FIG. 11B is a diagram for showing configuration of the table that indicates the correspondence between the indexes A and B and the thresholds α and β; and

FIG. 12 is a flowchart showing the operations of the image coding apparatus according to the embodiment of the present invention.

### DESCRIPTION OF THE PREFERRED EMBODIMENT(S)

The best embodiment for implementing the present invention is hereafter described with reference to the drawings.

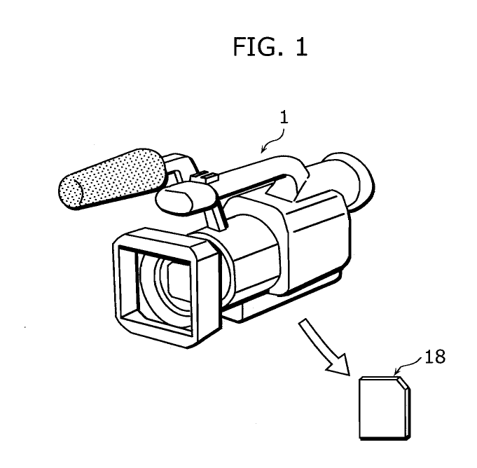

FIG. 1 shows an overview of the image coding apparatus according to the embodiment of the present invention.

Here, a digital video camera including imaging devices such as CCD and CMOS are shown as examples. When imaging night view and a dark room by the digital video camera, optical amplification is performed in order to improve sensitivity when receiving light, since the amount of incident light to an imaging device is small. The captured image can be recorded in the digital video camera and the detachably attached recording unit 18.

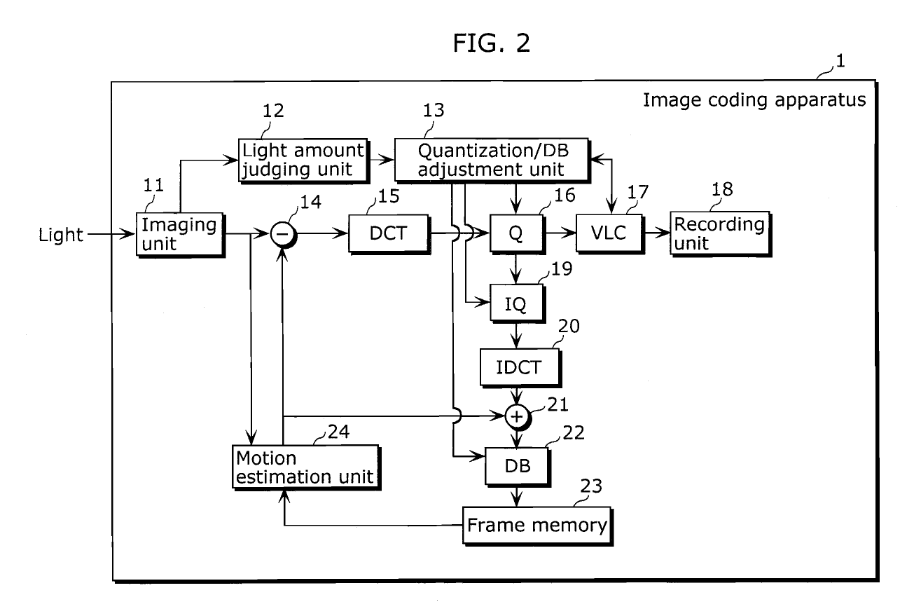

FIG. 2 is a block diagram showing a configuration of the image coding apparatus 1 according to the embodiment of the present invention.

The image coding apparatus 1 is compliant with H.264 (MPEG-4 AVC) image coding standard, and includes the imaging unit 11, the light amount judging unit 12, the quantization/deblocking (DB) adjustment unit 13, the subtractor 14, the discrete cosine transformation (DCT) unit 15, the quantization (Q) unit 16, the variable length coding (VLC) unit 17, the recording unit 18, the inverse quantization (IQ) unit 19, the inverse discrete cosine transformation (IDCT) unit 20, the adder 21, the deblocking (DB) unit 22, the frame memory 23, and the motion estimation unit 24. Characteristic components of the present invention are the imaging unit 11, the light amount judging unit 12, the quantization/deblocking adjustment unit 13, the quantization unit 16, and the deblocking unit 22. Other components, namely, the component with reference numerals 14 to 24 are same as a general image coding apparatus.

First, general components 14 to 24 are described.

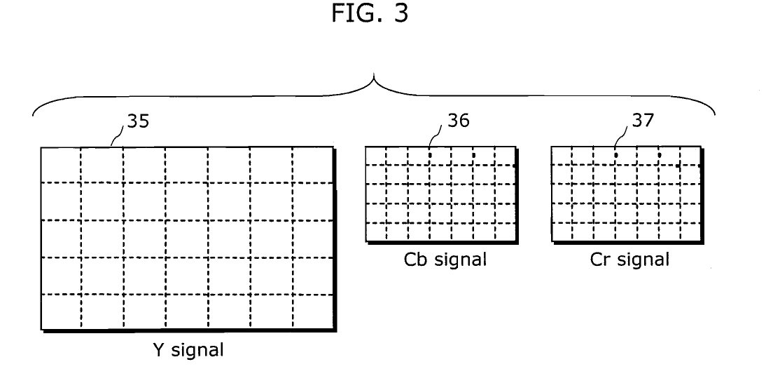

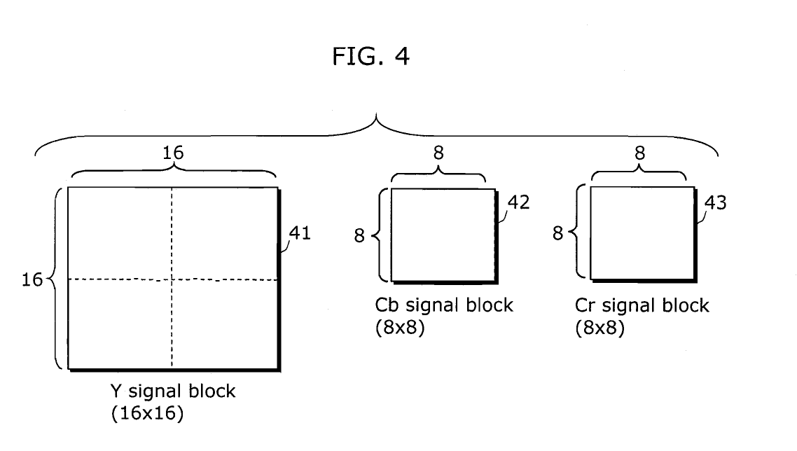

The digital image signal (hereinafter referred to as “image data”) outputted from the imaging unit 11 is processed per block. For example each of the picture included in a successive moving images are composed of one luma signal (Y signal 35) and two chroma signals (Cb signal 36 and Cr signal 37) as shown in FIG. 3. The image size of the chroma signal is half of that of the luma signal both in height and width. In addition, each picture in the moving image is divided into blocks called macroblock, and coded per macroblock. As shown in FIG. 4, the macroblock is composed of one Y signal block 41 having 16×16 pixels, the Cb signal block 42 and the Cr signal block 43 each of which has 8×8 pixels and spatially matches the Y signal block 41. The divided macroblock is inputted to the subtractor 14.

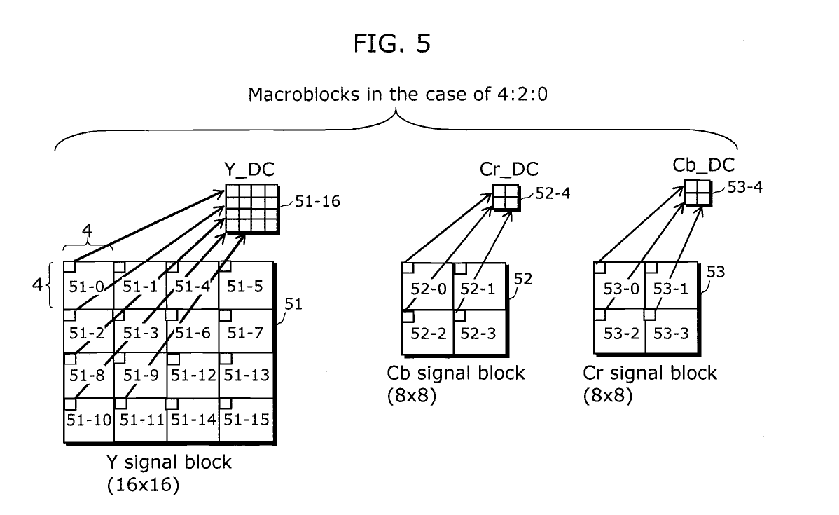

Here, difference of the image data of an intra predictive coded picture and intra predicted predictive data that is not shown here is calculated, and the difference is provided to the discrete cosine transformation unit 15, and resolved into orthogonal transformation coefficients which are coefficients of each frequency component by the discrete cosine transformation unit 15. More specifically, as shown in FIG. 5, the discrete cosine transformation unit 15 divides a macroblock into 24 4×4 pixel blocks (51-0 to 51-15, 52-0 to 52-3, 53-0 to 53-3) and performs orthogonal transformation on each block. The resolved orthogonal transformation coefficient is quantized by the quantization unit 16 based on the quantization information adjusted by the quantization/deblocking adjustment unit 13 (to be described later). Redundancy of the quantized orthogonal transformation coefficient is compressed by the variable length coding unit 17 and recorded in the recording unit 18 as a digital stream. The recording unit 18 is, for example, an optical disk, a memory card, a hard disk, and a tape.

Note that the quantized orthogonal transformation is provided to a local decoding loop in the inverse quantization unit 19 and the inverse discrete cosine transformation unit 20, deblocked in the deblocking unit 22, and temporarily recorded in the frame memory 23. The intra-predicted image which is temporarily stored in the frame memory 23 is used as a reference image for motion compensation. Note that, although it is not illustrated, difference data of predictive pixel predicted by neighboring block pixel in the frame per block size for orthogonal transformation and target pixel in the block is calculated, and the calculated difference data is provided to the subtractor 14 and the adder 21 as predictive data for intra prediction.

On the other hand, the subtractor 14 subtracts the image data of the picture which is inter-frame predictive coded from image data of a picture which have gone through motion compensation prediction by the motion estimation unit 24. The difference data is recorded in the recording unit 18 via the discrete cosine transformation unit 15, the quantization unit 16, and the variable length coding unit 17. The quantized difference data is inverse quantized by the inverse quantization unit 19, and is decoded to the original difference data by the inverse discrete cosine transformation unit 20. The adder 21 adds the motion compensation picture data of the picture to the decoded difference data, and outputs the sum as decoded image data.

The reproduced image data outputted from the adder 21 is inputted to the deblocking unit 22. The deblocking unit 22 performs deblocking based on deblocking information adjusted by the quantization/deblocking adjustment unit 13 (to be described later). The deblocked decoded image data is stored in the frame memory 23.

The motion estimation unit 24 performs motion prediction (estimates a motion vector) between current image data to be coded next and the decoded image data (reference image data) in the frame memory 23 in which image data that has been coded and decoded is stored. Furthermore, difference is calculated between the motion predicted reference image data and current image data, and motion compensated image data is generated.

The characteristic components of the present invention, namely, the imaging unit 11, the light amount judging unit 12, the quantization/deblocking adjustment unit 13, the quantization unit 16, the inverse quantization unit 19, and the deblocking unit 22 are described in detail.

The imaging unit 11 is an example of an imaging unit according to the present invention, and more specifically, is an imaging system including a lens, an aperture, an imaging device such as CCD or CMOS, a Correlated Double Sampling (CDS), an automatic gain control unit, an analog-digital converter, a white balance unit, and a gamma correction unit. The imaging unit 11 generates an optical signal by photoelectric conversion of incident light, and converts the optical signal to digital image data. The description is made assuming that the image data includes one luma signal and two chroma signals. The luma signal is luma component of image data and is hereafter referred to as “luma data”. The chroma signal is chroma component of image data and is hereafter referred to as “chroma data”. The specific feature of the present invention is that the amount of incident light to the imaging device is judged, and quantization and deblocking are performed based on the judgment result. The amount of incident light to the imaging device may be estimated based on the amount of optical signal, image data, and luma data, however, may also be estimated based on the aperture value information and gain value information as described below.

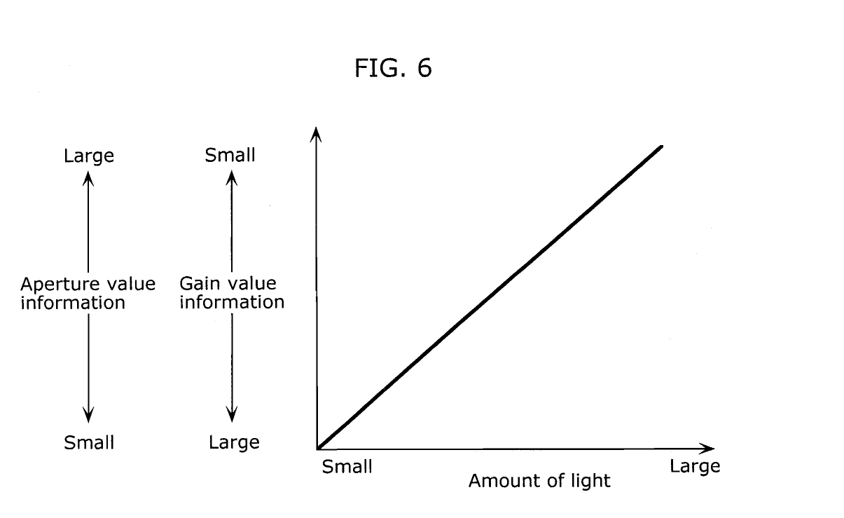

FIG. 6 illustrates relationship among the amount of incident light, the aperture value information in the imaging system, and the gain value in optical amplification.

The aperture value information indicates a value of aperture used for controlling amount of light, more specifically, controlling amount of light incident on the imaging device from the lens. As shown in the diagram, the more the aperture value is, the less the amount of incident light to the imaging device becomes. Meanwhile, the less the aperture value is, the more the amount of incident light to the imaging device becomes. Therefore, the aperture value is set to be small when the automatic aperture adjustment is effective, since the amount of incident light needs to be increased in a dark area than a well-lighted area. In addition, FIG. 6 indicates that since the more the gain value in the automatic gain control unit (the gain value information), the less the amount of incident light to the imaging device becomes, light is amplified with higher gain. The imaging unit 11 provides information that can be used for judgment when estimating amount of incident light to the imaging device (hereafter referred to as “light amount information”) to the light amount judging unit 12.

The light amount judging unit 12 is an example of the light amount judging unit according to the present invention, and judges whether the amount of incident light to the imaging device is smaller than a predetermined amount (threshold value) based on the light amount information provided by the imaging unit 11. For example, when the aperture value is smaller than the predetermined value, when the gain value is larger than the predetermined value, or when the aperture value is smaller than the predetermined value and the gain value is larger than the predetermined value, it is judged that the amount of incident light to the imaging device is smaller than the predetermined amount. When the amount of incident light is smaller than the predetermined amount, it can be assumed that the image has been taken in a dark place and under an imaging condition where chromatic noise tends to be generated. The threshold value (predetermined amount) as incident light judgment criteria needs to be set in advance. More specifically, the light amount information with which chromatic noise tends to be generated is checked in advance, and the light amount information is set as the judgment criteria (threshold). The number of threshold values may not be particularly limited. For example, multiple threshold values may be set depending on the probability of chromatic noise and the size of chromatic noise.

The quantization/deblocking adjustment unit 13 adjusts quantization information and inverse quantization information based on the judgment result of the light amount judging unit 12, and provides the quantization unit 16 and the inverse quantization unit 19 with the adjusted quantization information and the adjusted inverse quantization information. The quantization information and the inverse quantization information (hereafter collectively referred to as “quantization information”) are quantization parameters (QP) for, for example, luma and chroma. Quantization step (quantization width) is derived from the quantization parameter. Orthogonal transformation coefficients of luma and chroma are divided by the derived quantization width (quantization). Conversely, multiplication the quantization value with quantization width generates orthogonal transformation coefficients (inverse quantization). In addition, the quantization/deblocking adjustment unit 13 adjusts the deblocking information based on the judgment result by the light amount judging unit 12, and provides the deblocking unit 22 with adjusted deblocking information. The deblocking information is, for example, an offset value of the smoothness of the deblocking filter. Furthermore, the quantization/deblocking adjustment unit 13 monitors the code amount of the variable length coding unit 17, and adjusts quantization information so that the code amount of the variable length coding unit 17 becomes the predetermined code amount. The quantization information adjusted by the quantization/deblocking adjustment unit 13 is compressed in redundancy by the variable length coding unit 17, and recorded in the recording unit 18 as digital stream.

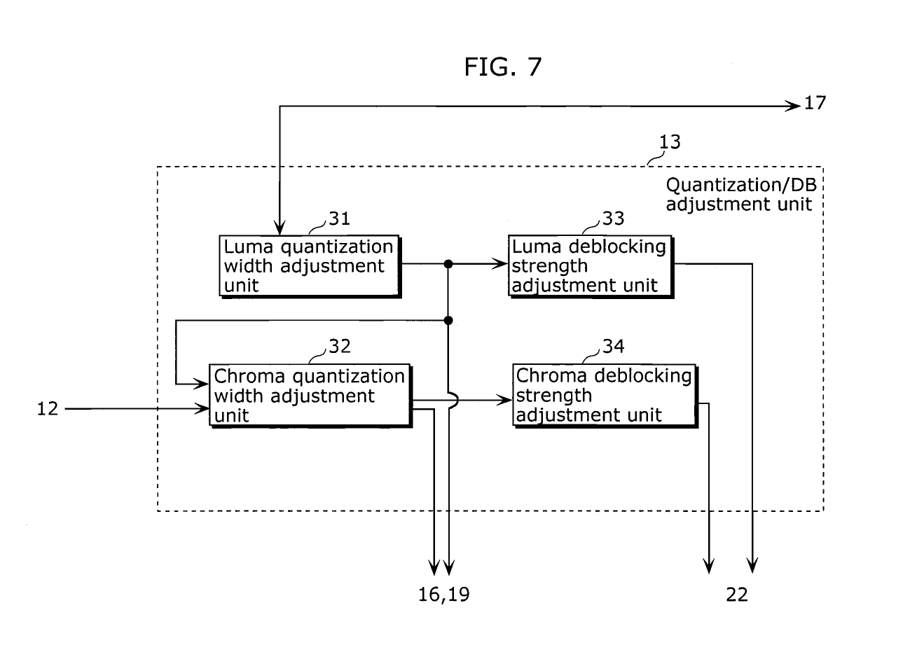

FIG. 7 is a block diagram showing detailed configuration of the quantization/deblocking adjustment unit 13 according to the embodiment of the present invention. The quantization/deblocking adjustment unit 13 is an essential component of the present invention, and includes the luma quantization width adjustment unit 31, the chroma quantization width adjustment unit 32, the luma deblocking strength adjustment unit 33, and the chroma deblocking strength adjustment unit 34.

The luma quantization width adjustment unit 31 obtains the code amount information from the variable length coding unit 17, and adjusts quantization information of the luma data. More specifically, quantization information which minimizes the quantization distortion is set so that the code amount of the variable length coding unit 17 matches the predetermined code amount that has been set. The luma quantization width adjustment unit 31 is then provides the quantization unit 16 and the inverse quantization unit 19 with the adjusted quantization information, as well as the chroma quantization width adjustment unit 32 and the luma deblocking strength adjustment unit 33.

In addition, the luma quantization width adjustment unit 31 determines the quantization parameter of luma data in the same manner without being dependent on the judgment result by the light amount judging unit 12.

The chroma quantization width adjustment unit 32 obtains the quantization information from the luma quantization width adjustment unit 31 as well as obtaining the judgment result from the light amount judging unit 12. Furthermore, the chroma quantization width adjustment unit 32 obtains quantization information of the chroma data by adjusting the quantization information obtained by the luma quantization width adjustment 31 based on the judgment result obtained by the light amount judging unit 12. For example, when judgment result indicating that the amount of incident light is smaller than the predetermined amount is obtained, it is assumed that the image has been taken in a dark place and under an imaging condition where chromatic noise tends to be generated. Thus, the quantization information is adjusted so that quantization is to be performed rougher than usual. Conversely, when judgment result indicating that the amount of incident light is larger than the predetermined amount is obtained, it is assumed that the image has been taken in a bright place and under an imaging condition where chromatic noise is less likely to be generated (under a regular imaging condition). Thus the quantization information is determined using a regular method without adjusting the quantization information. The quantization information outputted from the chroma quantization width adjustment unit 32 is provided to the quantization unit 16, the inverse quantization unit 19, and the chroma deblocking strength adjustment unit 34.

Unlike conventional coding methods (such as MPEG-2 and MPEG-4), H.264 (MPEG-4 AVC) image coding method is capable of controlling quantization of chroma data. More specifically, in conventional coding methods, quantization of the chroma data cannot be set independently of the luma data. In the H.264 (MPEG-4 AVC) image coding method, it is possible to set quantization control of the chroma data to certain extent independently of the luma data as an offset of the quantization parameter with respect to the chroma data (hereinafter referred to as the chroma quantization parameter) although the setting is still correlated with (added to) the quantization information of the luma data.

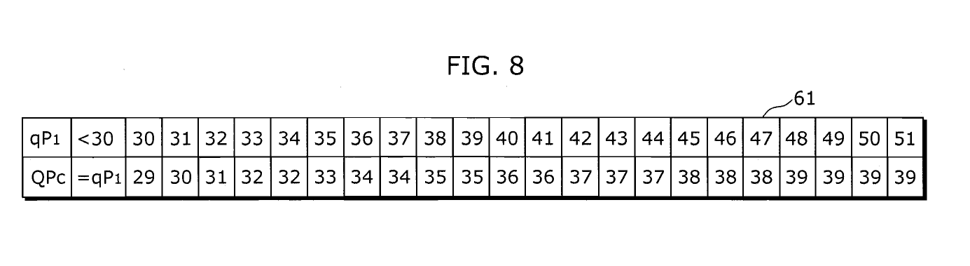

More specifically, the chroma quantization parameter QPc is determined based on the value qP1 calculated by the equation (1) shown below and the table 61 shown in FIG. 8. QPy shown in the equation (1) denotes a quantization parameter of luma data (hereafter referred to as luma quantization parameter). Chroma_qp_index_offset is a parameter included in the parameter set that can be set per picture, and is an offset value of the luma quantization parameter QPy and the chroma quantization parameter QPc. The table 61 shown in FIG. 8 indicates relationship between the value of qP1 and the value of luma quantization parameter QPy. More specifically, the chroma quantization width adjustment unit 32 calculates the value of qP1 using the equation (1) below. The chroma quantization width adjustment unit 32 determines a value corresponding to the value of calculated qP1 shown in the table 61 as the chroma quantization parameter QPc.

qP₁=Clip3(0,51,QPy+Chroma_{—}qp_index_offset) Equation (1)

Here, Clip 3 shown in the equation (1) indicates clipping to qP1=0 when QPy+Chroma_qp_index_offset is less than 0, and to qP1=51 when QPy+Chroma_qp_index_offset is over 51, and qP1=QPy+Chroma_qp_index_offset in any other case.
Note that a value between −12 to +12 can be set as an offset value Chroma_qp_index_offset. Setting a negative offset value Chroma_qp_index_offset consequently minimizes the quantization width of the chroma data. For example, when −6 is set as the offset value, the quantization width of the chroma data can be set to half of the original quantization width. More specifically, the quantization unit 16 uses the offset value Chroma_qp_index_offset as an adjustment value when referring quantization matrix upon determining the quantization width of the chroma data.
For example, it is assumed that the luma quantization parameter QPy which is the luma information set by the luma quantization width adjustment unit 31 is 38. Furthermore, the offset value Chroma_qp_index_offset used for the cases where the light amount information obtained by the light amount judging unit 12 (the amount of light in a dark area where chromatic noise tends to be generated) is smaller than the predetermined value is +12. In this case, the equation (1) shows that qP1 is 50, and the table 61 shows the chroma quantization parameter QPc is 39.
On the other hand, the offset value Chroma_qp_index_offset in the case where the light amount information obtained by the light amount judging unit 12 is larger than the predetermined value is 0, which is set as a default value. With this, the chroma quantization parameter QPc is set only by the luma quantization parameter QPy. For example, when the luma quantization parameter QPy is 38, the chroma quantization parameter QPc is 35.
As described above, the chroma quantization width adjustment unit 32 determines a value corresponding to the value of the luma quantization parameter QPy determined by the luma quantization width adjustment unit 31 as the chroma quantization parameter QPc when the light amount judging unit 12 judges that the amount of light incident on the imaging unit 11 is larger than the predetermined amount.
On the other hand, the chroma quantization width adjustment unit 32 adds the offset value Chroma_qp_index_offset set to be positive value to the luma quantization parameter QPy to calculates qP1 when the light amount judging unit 12 judges that the amount of light incident on the imaging unit 11 is smaller than the predetermined amount. The chroma quantization width adjustment unit 32 determines a value that corresponds to the value of qP1 according to the table 61 as the chroma quantization parameter. As described above, the chroma quantization width adjustment unit 32 adjusts the chroma quantization parameter in such a manner that the chroma quantization parameter is larger than the chroma quantization parameter that has been determined using a regular method (in the case where the amount of light incident on the imaging unit 11 is larger than the predetermined amount).

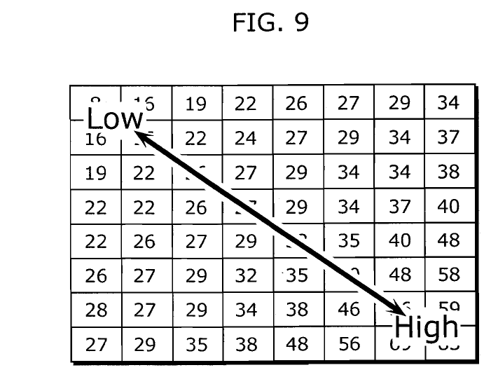

Furthermore, in the H.264 (MPEG-4 AVC) image coding method, the quantization matrix of the chroma data can be set independently of the quantization matrix of the luma data. The description above indicates that the chroma quantization width adjustment unit 32 adjusts the offset value of the quantization width Chroma_qp_index_offset. Alternatively, the chroma quantization width adjustment unit 32 may adjust the quantization matrix value of the chroma data in such a manner that the frequency component in high frequency may be reduced or deleted (see FIG. 9). In this case, it is needless to say that the quantization unit 16 quantizes the chroma data using the adjusted quantization matrix. Note that there are cases where adjusting the quantization matrix value and adjusting the quantization width are referred to as “adjusting the quantization width” without distinguishing each other since adjusting the quantization matrix value consequently adjusts the quantization width.

The luma deblocking strength adjustment unit 33 calculates the deblocking information of the luma data based on the quantization information adjusted by the luma quantization width adjustment unit 31. Then the calculated deblocking information is provided with the deblocking unit 22.

In addition, the luma deblocking strength adjustment unit 33 determines the deblocking information of luma data in the same manner without being dependent on the judgment result by the light amount judging unit 12.

The chroma deblocking strength adjustment unit 34 obtains quantization information of the chroma data from the chroma quantization width adjustment unit 32. Then the chroma deblocking strength adjustment unit 34 adjusts the deblocking information of the chroma data based on the quantization information of the chroma data obtained by the chroma quantization width adjustment unit 32, and obtains the deblocking information of the chroma data. For example, when the quantization information of the chroma data is adjusted by the chroma quantization width adjustment unit 32, quantization rougher than regular quantization is performed. Thus, in this case, it is assumed that the block noise tends to be generated, and adjusts the deblocking filter strength so that the deblocking filter strength is stronger than usual. Conversely, when the quantization information of the chroma data is not adjusted by the chroma quantization width adjustment unit 32, the quantization is performed as usual. Accordingly, in this case, it is assumed that the block noise is less likely to be generated. Thus, the deblocking information is not adjusted and the deblocking information is determined using the regular method. The deblocking information outputted from the chroma deblocking strength adjustment unit 34 is provided to the deblocking unit 22.

In the H.264 (MPEG-4 AVC) image coding method, unlike the conventional coding methods (MPEG-2 and MPEG-4), the deblocking filter is set on the local decoding side. The strength of the deblocking filter is higher as the quantization width varies, and can be set as offset per slice. More specifically, varying offset of the deblocking filter as well as the offset of the quantization width of the chroma data enables adjustment of the deblocking filter strength.

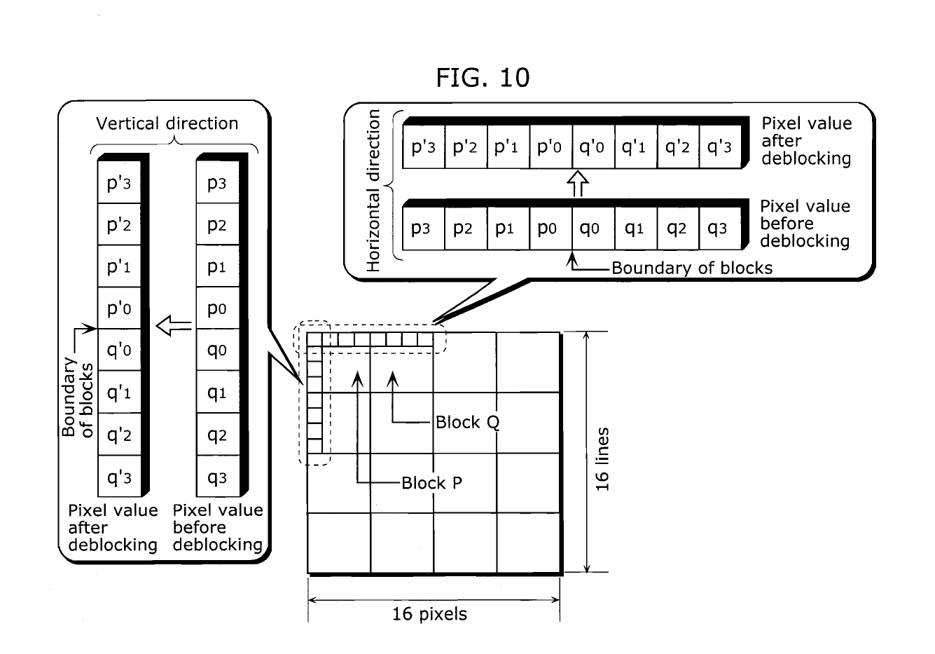

For example, FIG. 10 shows block boundaries in each block (horizontal 4 pixels×vertical 4 lines) and pixels in the block (horizontal, vertical) within a macroblock that is 16 pixels×16 lines Here, the filter strength (smoothness) for deblocking which suppresses the block noise is determined in consideration of coding conditions that could generate gap (block noise) among blocks (whether the block is an intra coding block or not, whether the block has an orthogonal transformation coefficient, whether the reference frame is identical or not, and quantization parameter values of each blocks) and absolute difference values among pixels interposing the block boundary.

The coding condition of deblocking and the differential absolute value neighboring the block boundary are naturally determined at the time of coding, however, the user may adjust the deblocking filter strength. More specifically, the chroma deblocking strength adjustment unit 34 can adjust the deblocking filter strength using an offset value. The offset value can be set by two parameters included in the bitstream, namely, slice_alpha_c0_offset_div2 and slice_beta_offset_div2. The values set in the two parameters relate to index A and index B calculated under the coding condition (more particularly, quantization parameter value (quantization width) of a block), and threshold values α and β for deblocking according to the index A and the index B are modified. Modifying the thresholds α and β changes filter strength for deblocking.

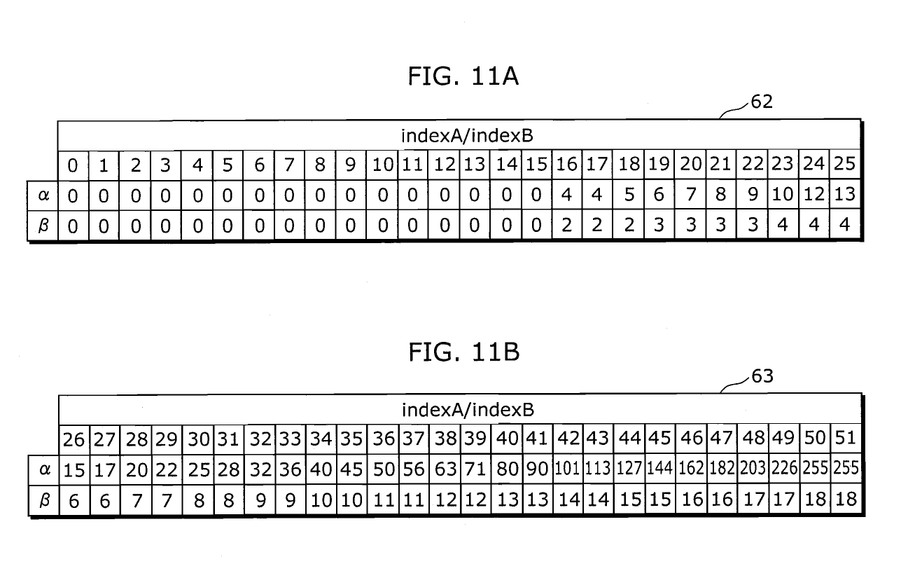

More specifically, the deblocking filter is used depending on conditions of block boundaries of images which is referred to as Boundary Strength (BS) and relationship between differential absolute values between the pixels located on the block boundaries as shown in FIG. 10, and threshold values α and β. For example, deblocking filter is used when the differential absolute value of the pixel p0 and the pixel q0 is smaller than the threshold value α and both differential absolute value between the pixel p0 and the pixel p1 and the absolute difference value between the pixel q0 and the pixel q1 are smaller than the threshold β except for the case where neither the block Q nor the block P in FIG. 10 belongs to intra macroblock, where neither the block Q not the block P has transformation coefficient, and where both the block Q and the block P have identical reference frames and motion vector values (corresponds to Bs value=0).
The index A and the index B are calculated using the equations (2) from the two parameters slice_alpha_c0_offset_div2 and slice_beta_offset_div2.
FIG. 11A and FIG. 11B illustrates an example of the table 62 and the table 63 respectively showing the correspondence between the values of index A and index B and the threshold values α and β. The value of threshold α corresponding to the value of index A is determined by referring to the tables 62 and 63. The value of threshold β corresponding to the value of index B is determined by referring to the tables 62 and 63.
More specifically, the threshold values α and β are larger by setting slice_alpha_c0_offset_div2 and slice_beta_offset_div2, and the deblocking filter is likely to be used. Note that in the equations (2), qPav is an average value of quantization parameter of the block Q and block P in FIG. 10. In addition, qPp and qPq are chroma quantization parameters outputted by the chroma quantization width adjustment unit 32, and are respectively chroma quantization parameters of the block P and the block Q.

FilterOffsetA=slice_alpha_c0_offset_div2<<1

FIlterOffsetB=slice_beta_offset_div2<<1

qPav=(qPp+qPq+1)>>1

indexA=Clip3(0,51,qPav+FilterOffsetA)

indexB=Clip3(0,51,qPav+FilterOffsetB) Equations (2)

As described above, the chroma deblocking strength adjustment unit 34 calculates an average value qPav using the chroma quantization parameter outputted by the chroma quantization width adjustment unit 32 when the chroma quantization width adjustment unit 32 does not adjust the chroma quantization parameter (when the amount of light incident on the imaging unit 11 is larger than the predetermined amount) and calculates index A and index B using the calculated average value qPav. The chroma deblocking strength adjustment unit 34 determines values corresponding to the values of index A and index B as the threshold values α and β according to the tables 62 and 63. More specifically, the deblocking filter strength for the chroma data is determined.
On the other hand, the chroma deblocking strength adjustment unit 34 calculates an average value qPav using the chroma quantization parameter outputted by the chroma quantization width adjustment unit 32 when the chroma quantization width adjustment unit 32 has adjusted the chroma quantization parameter (when the amount of light incident on the imaging unit 11 is smaller than the predetermined amount). Furthermore, the chroma deblocking strength adjustment unit 34 calculates the index A by adding slice_alpha_c0_offset_div2 to the calculated average value, and calculates the index B by adding slice_beta_offset_div2 to the average value qPav. The chroma deblocking strength adjustment unit 34 determines values corresponding to the values of index A and index B as the threshold values α and β according to the tables 62 and 63. More specifically, the deblocking filter strength for the chroma data is determined.
As described above, the chroma quantization width adjustment unit 32 adjusts the filter strength of the deblocking for the chroma data in such a mariner that the filter strength is higher than the filter strength in the case where the filter strength has been determined using a regular method (in the case where the amount of light incident on the imaging unit 11 is larger than the predetermined amount).

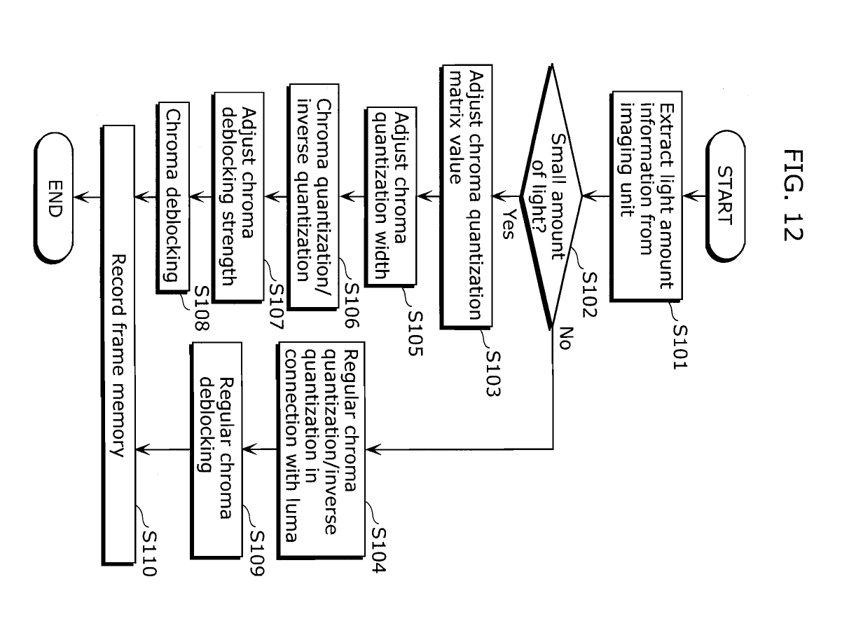

FIG. 12 is a flowchart showing the operations of the image coding apparatus 1 according to the embodiment of the present invention. Operations of the image coding apparatus 1 for effectively suppressing chromatic noise in the dark and reducing block noise that tends to be generated at the same time are described with reference to FIG. 12.

First, light amount information is extracted from the imaging unit 11 (step S101). As described above, the aperture value information may be used as the light amount information. Furthermore, the adjusted value for automatic gain control that amplifies the received light, the size of the photoelectric converted signal, the size of luma signal converted to the digital image data as light amount information.

The light amount information extracted in step S101 is provided with the light amount judging unit 12. The light amount judging unit 12 judges whether the amount of incident light is smaller than the threshold value based on the provided light amount information (step S102). When it is judged that the amount of incident light is smaller than the predetermined threshold value (Yes), it is assumed that the captured video is dark, and the chroma quantization matrix value is adjusted (step S103). Conversely, when it is judged that the amount of incident light is not smaller than the threshold value (No), it is assumed that the captured video is not dark, and the regular chroma quantization and inverse quantization in conjunction with the luma are performed (step S104).

In step S103, the quantization/deblocking adjustment unit 13 adjusts the quantization matrix value of the chroma data. In this case, based on the judgment result in step S102, it is assumed that the captured video is dark and under the condition that chromatic noise tends to be generated. Thus, the quantization matrix value is adjusted in such a manner that the frequency component of the chroma data (particularly high frequency component) is reduced by enlarging (increasing) the chroma quantization matrix value per slice.

In step S105, the offset value of the chroma quantization width is adjusted such that the offset value is larger compared to the regular quantization width (namely, the chroma quantization width correlated with the luma). Either one of, or both steps S103 and S105 may be executed. This is dependent on the amount of light extracted in step S102. For example, when it is judged that the light amount is extremely small in step S102, it can be assumed that generation of the dark chromatic noise is prominent, and thus it is preferable to execute both steps S103 and S105. In this case, multiple steps of threshold values are set in step S102.

The quantization information of the chroma data adjusted in step S103 or S105 is provided to the quantization unit 16 and the inverse quantization unit 19. The quantization unit 16 and the inverse quantization unit 19 perform quantization and inverse quantization based on the quantization information of the adjusted chroma data (step S106).

The chroma data inversely quantized in step S106 is provided to the deblocking unit 22. The quantization/deblocking adjustment unit 13 adjusts the deblocking strength of the chroma data which has been quantized and inverse quantized using the quantization information of the chroma data adjusted in steps S103 and S105 and reconstructed (step S107). Note that regular chroma deblocking is performed on the chroma block reconfigured by the chroma quantization and inverse quantization correlated with the luma in step S104 (step S109).

Note that, in step S107, the quantization/deblocking adjustment unit 13 largely adjusts the offset value of the deblocking filter strength in order to suppress the block noise of the chroma data more. The strength of the deblocking filter of the chroma data adjusted in step S107 is provided to the deblocking unit 22. The deblocking unit 22 deblocks the chroma data based on the deblocking filter strength adjusted in step S107 (step S108). The chroma data that has been deblocked in step S108 or step S109 is provided to the frame memory 23 (step S110), and the series of chromatic noise reduction for the chroma data is completed.

As described above, according to the image coding apparatus of the embodiment of the present invention, it is possible to effectively suppress dark noise generated in the imaging system, particularly chromatic noise on the coding side, as well as block noise that tends to be generated on the coding side simultaneously.

Furthermore, the image coding apparatus according to the embodiment of the present invention is capable of adjusting the quantization width of the chroma data independently of the luma data. Therefore, the image coding apparatus is particularly effective for maintaining the luma (contour) while suppressing the chromatic noise. In other words, the present invention is exceptionally practical for the cases where only suppressing chromatic noise is effective since the noise caused by the variation in luma is not prominent in the dark.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The image coding apparatus and the image coding method according to the present invention can effectively suppress the chromatic noise generated in the imaging system, particularly the chromatic noise generated in the dark. More specifically, the image coding apparatus and the image coding method is suitable for digital video cameras and digital cameras which capture and record moving picture data.

What is claimed is:

1. An image coding apparatus that codes image data, comprising:
an imaging unit configured to output the image data;
a light amount judging unit configured to judge whether amount of incident light on said imaging unit is smaller than a predetermined amount;
a chroma quantization width adjustment unit configured to determine a chroma quantization width using a first method when said light amount judging unit judges that the amount of the incident light is larger than the predetermined amount, and to adjust the chroma quantization width such that the chroma quantization width is larger than a quantization width determined using the first method when said light amount judging unit judges that the amount of the incident light is smaller than the predetermined amount, the chroma quantization width being a quantization width of chroma data that is chroma component of the image data;
a chroma quantization unit configured to quantize, as a part of the coding, the chroma data using the chroma quantization width that has been determined or adjusted by said chroma quantization width adjustment unit;
a luma quantization width adjustment unit configured to determine a luma quantization width using a second method without being dependent on the judgment result by said light amount judging unit, the luma quantization width being a quantization width of luma data that is luma component of the image data; and
a luma quantization unit configured to quantize, as a part of the coding, the luma data using the luma quantization width that has been determined by said luma quantization width adjustment unit.

2. The image coding apparatus according to claim 1, further comprising:
a chroma deblocking strength adjustment unit configured to determine a chroma deblocking strength using a third method when the chroma quantization width is not adjusted by said chroma quantization width adjustment unit, and to adjust the chroma deblocking strength such that the chroma deblocking strength is higher than a deblocking filter strength determined using the third method when the chroma quantization width is adjusted by said chroma quantization width adjustment unit, the chroma deblocking strength being a deblocking filter strength of the chroma data;
a chroma deblocking unit configured to deblock, as a part of the coding, the chroma data using the chroma deblocking strength that has been determined or adjusted by said chroma deblocking strength adjustment unit;
a luma deblocking strength adjustment unit configured to determine a luma deblocking strength using a fourth method without being dependent on the judgment result by said light amount judging unit, the luma deblocking strength being a deblocking filter strength of the luma data; and
a luma deblocking unit configured to deblock, as a part of the coding, the luma data using the luma deblocking strength that has been determined by said luma deblocking strength adjustment unit.

3. The image coding apparatus according to claim 1,
wherein said chroma quantization width adjustment unit is configured to adjust a quantization matrix value of the chroma data so as to lower or reduce high frequency component when said light amount judging unit judges that the amount of the incident light is smaller than the predetermined amount, and
said chroma quantization unit is configured to quantize the chroma data using the adjusted quantization matrix value.

4. The image coding apparatus according to claim 1,
wherein said light amount judging unit is configured to judge that the amount of incident light is smaller than the predetermined amount in at least one of the following cases: where an aperture value used for controlling the amount of incident light is smaller than a predetermined value; and where a gain amplification value of a gain for amplifying the received light is larger than a predetermined value.

5. The image coding apparatus according to claim 1,
wherein said light amount judging unit is configured to judge that the amount of incident light is smaller than the predetermined amount when the size of a luminance signal of incident light is smaller than the predetermined value.

6. The image coding apparatus according to claim 1,
wherein said chroma quantization width adjustment unit is configured to determine, according to a table that indicates correspondence between values of the luma quantization width and values of the chroma quantization width, a value corresponding to a value of the luma quantization width that has been determined by said luma quantization width adjustment unit as the chroma quantization width when said light amount judging unit judges that the amount of the incident light is larger than the predetermined amount, and to adjust the chroma quantization width by adding an offset value to the luma quantization width that has been determined by said luma quantization width adjustment unit and determining, according to the table, a value corresponding to a value of the luma quantization width to which the offset value is added as the chroma quantization width when said light amount judging unit judges that the amount of the incident light is smaller than the predetermined amount.

7. The image coding apparatus according to claim 2,
wherein said chroma deblocking strength adjustment unit is configured to determine, according to a table that indicates correspondence between values of the chroma quantization width and values of the chroma deblocking strength a value corresponding to a value of the chroma quantization width that has been determined by said chroma quantization width adjustment unit as the chroma deblocking strength when the chroma quantization width is not adjusted by said chroma quantization width adjustment unit, and to adjust the chroma deblocking strength by adding an offset value to the chroma quantization width that has been determined by said chroma quantization width adjustment unit and determining, according to the table, a value corresponding to a value of the chroma quantization width to which the offset value is added as the chroma deblocking strength when the chroma quantization width is not adjusted by said chroma quantization width adjustment unit.

8. The image coding apparatus according to claim 1,
wherein said image coding apparatus is compliant to the H.264 image coding standard.

9. An image coding method for coding image data, comprising:
imaging in which an imaging unit outputs the image data;
light-amount-judging in which it is judged whether amount of incident light on the imaging unit is smaller than a predetermined amount;
chroma-quantization-width-adjusting in which a chroma quantization width is determined using a first method when it is judged in said light-amount-judging, that the amount of the incident light is larger than the predetermined amount, and the chroma quantization width is adjusted such that the chroma quantization width is larger than a quantization width determined using the first method when it is judged in said light-amount-judging, that the amount of the incident light is smaller than the predetermined amount, the chroma quantization width being a quantization width of chroma data that is chroma component of the image data;
chroma-quantizing, as a part of the coding, the chroma data using the chroma quantization width that has been determined or adjusted in said chroma-quantization-width-adjusting;
luma-quantization-width-adjusting in which a luma quantization width is determined using a second method without being dependent on the judgment result in said light-amount-judging, the luma quantization width being a quantization width of luma data that is luma component of the image data; and
luma-quantizing, as a part of the coding, the luma data using the luma quantization width that has been determined in said luma-quantization-width-adjusting.

10. The image coding method according to claim 1, further comprising:
chroma-deblocking-strength-adjusting in which a chroma deblocking strength is determined using a third method when the chroma quantization width is not adjusted in said chroma-quantization-width-adjusting, and the chroma deblocking strength is adjusted such that the chroma deblocking strength is higher than a deblocking filter strength determined using the third method when the chroma quantization width is adjusted in said chroma-quantization-width-adjusting, the chroma deblocking strength being a deblocking filter strength of the chroma data;
chroma-deblocking, as a part of the coding, the chroma data using the chroma deblocking strength that has been determined or adjusted in said chroma-deblocking-strength-adjusting;
luma-deblocking-strength-adjusting in which a luma deblocking strength is determined using a fourth method without being dependent on the judgment result in said light-amount-judging, the luma deblocking strength being a deblocking filter strength of the luma data; and
luma-deblocking, as a part of the coding, the luma data using the luma deblocking strength that has been determined in said luma deblocking strength adjusting.

11. A computer program product for coding image data which, when loaded into a computer, allows the computer to execute:
imaging in which an imaging unit outputs the image data;
light-amount-judging in which it is judged whether amount of incident light on the imaging unit is smaller than a predetermined amount;
chroma-quantization-width-adjusting in which a chroma quantization width is determined using a first method when it is judged in said light-amount-judging, that the amount of the incident light is larger than the predetermined amount, and the chroma quantization width is adjusted such that the chroma quantization width is larger than a quantization width determined using the first method when it is judged in said light-amount-judging, that the amount of the incident light is smaller than the predetermined amount, the chroma quantization width being a quantization width of chroma data that is chroma component of the image data;
chroma-quantizing, as a part of the coding, the chroma data using the chroma quantization width that has been determined or adjusted in said chroma-quantization-width-adjusting;
luma-quantization-width-adjusting in which a luma quantization width is determined using a second method without being dependent on the judgment result in said light-amount-judging, the luma quantization width being a quantization width of luma data that is luma component of the image data; and
luma-quantizing, as a part of the coding, the luma data using the luma quantization width that has been determined in said luma-quantization-width-adjusting.

12. The computer program product according to claim 11, when loaded into the computer, further allows the computer to execute:
chroma-deblocking-strength-adjusting in which a chroma deblocking strength is determined using a third method when the chroma quantization width is not adjusted in said chroma-quantization-width-adjusting, and the chroma deblocking strength is adjusted such that the chroma deblocking strength is higher than a deblocking filter strength determined using the third method when the chroma quantization width is adjusted in said chroma-quantization-width-adjusting, the chroma deblocking strength being a deblocking filter strength of the chroma data;
chroma-deblocking, as a part of the coding, the chroma data using the chroma deblocking strength that has been determined or adjusted in said chroma-deblocking-strength-adjusting;
luma-deblocking-strength-adjusting in which a luma deblocking strength is determined using a fourth method without being dependent on the judgment result in said light-amount-judging, the luma deblocking strength being a deblocking filter strength of the luma data; and
luma-deblocking, as a part of the coding, the luma data using the luma deblocking strength that has been determined in said luma deblocking strength adjusting.
